(19) United States
(12) Patent Application Publication
(10) Pub. No.: US 2009/0004540 A1
(43) Pub. Date: Jan. 1, 2009

(54) Fuel Cell and Laminate

(76) Inventors: Fumishige Shizuku, Aichi-ken (JP); Seiji Sano, Sizuoka-ken (JP); Takashi Kajiwara, Shizuoka-ken (JP); Hiromichi Sato, Kanagawa-ken (JP); Yutaka Hotta, Shizuoka-ken (JP); Yoshifumi Ohta, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/160,123

(22) PCT Filed: Jan. 16, 2007
(86) PCT No.: PCT/IB2007/000108

§ 371 Date: Jul. 7, 2008

(30) Foreign Application Priority Data
Jan. 17, 2006 (JP) 2006-008508

(51) Int. Cl. H01M 2/08

(52) U.S. Cl. 429/35

(57) ABSTRACT

In a seal gasket-integrated MEA (45) in which a frame (450) having a sealing part (459) is integrally formed around a membrane-electrode assembly (MEA section 451), a high-rigidity member (458) having higher rigidity than the frame (450) is provide around a frame (450) having relatively low rigidity.

### FIELD OF THE INVENTION

The present invention relates to a fuel cell and a laminate, and more particularly, to a laminate having an anode and a cathode on both sides of a electrolyte membrane, and a fuel cell having a stack structure in which a plurality of the laminates are stacked on top of each other with separators that sandwich the laminates.

### BACKGROUND OF THE INVENTION

Fuel cells, which generate electricity through an electrochemical reaction between hydrogen and oxygen, are attracting attention as energy sources. A fuel cell has a stack structure in which membrane-electrode assemblies each having an anode (hydrogen electrode) and a cathode (oxygen electrode) on both sides of a electrolyte membrane and separators are stacked alternately (the fuel cell having such a stack structure is hereinafter referred to also as “fuel cell stack”).

As for such fuel cell stacks, various techniques to prevent leakage of reactant gases (fuel gas and oxidant gas) have been proposed. For example, JP-A-2000-133290 describes a configuration of a fuel cell stack in which each membrane-electrode assembly is integrated, with an elastic packing member. JP-A-2004-6104 describes a configuration of a fuel cell stack in which seal members are interposed between membrane-electrode assemblies and separators. In such fuel cell stacks, a fastening load is generally applied in the stacking direction of the fuel cell stack to ensure the sealability of the elastic packing members or the seal members.

However, a high pressure of, for example, about 200 to 300 (kPa) is sometimes applied to reactant gas passages in the fuel cell stack when gases are supplied thereto. Thus, even when a fastening load is applied to a fuel cell stack, the high pressure may deform the seal members and displace the seal members in a direction parallel to the stacking plane until the sealability of the seal members is decreased. Such a defect is often observed when a material having a relatively low rigidity such as rubber is used for the seal members.

### DISCLOSURE OF THE INVENTION

It is an object of the present invention to prevent deterioration of sealability caused by deformation of seal members at supplying of reactant gases in a fuel cell stack.

A first aspect of the present invention relates to a fuel cell having a stack structure in which a plurality of laminates each including an anode and a cathode disposed on both sides of a electrolyte membrane are stacked on top of each other faith separators that sandwich the laminates. Each of the laminates has a seal member integrally formed on an outer periphery thereof for preventing leakage of reactant gases supplied onto a surface of the laminate, and a high-rigidity member having higher rigidity than the seal member surrounds at least a part of the seal member.

In the fuel cell, since the high-rigidity member can prevent deformation of the seal member, deterioration of sealability caused by deformation of the seal material at supplying of reactant gases can be prevented in a fuel cell stack.

The seal member may be made of an elastic material.

A seal member made of an elastic material is especially useful since it has relatively low rigidity and can be easily changed in shape.

The high-rigidity member may be formed integrally with the seal member.

When a laminate having a seal member integrally formed on an outer periphery thereof is produced, the outer peripheral part of the seal member is sometimes deformed largely because of a difference in linear expansion coefficient between the laminate and the seal member. However, since a high-rigidity member surrounding at least a part of the seal member is integrally formed, deformation of the seal member caused by a difference in linear expansion coefficient between the laminate and the seal member can be prevented when the laminate having a seal member integrally formed on an outer periphery thereof is produced.

The high-rigidity member may have a restraining portion for preventing deformation of the seal member in the stacking direction of the stack structure.

Then, deterioration of sealability caused by excessive deformation of the seal member in the stacking direction of the stack structure can be prevented

The high-rigidity member may have a fitting portion fittable with at least a part of an outer periphery of the separator.

Then, positioning in a surface direction in stacking the laminates and the separators can be made with ease and high accuracy.

Also, when the seal member is made of a highly shrinkable material, the shrinking force of the seal member may be applied on the laminate and damage the anode or the cathode. When the outer periphery of the separator and the fitting portion of the high-rigidity member are fitted together, since outward tension is exerted on the seal member, the shrinking force of the seal member on the laminate can be decreased. Therefore, breakage of the anode and cathode of the laminate can be prevented.

The separator and the high-rigidity member may have positioning through holes for use in positioning in a surface direction in stacking.

Then, a plurality of separators and a plurality of laminates are stacked alternately, positioning in a surface direction can be made with ease and high accuracy.

Although the number of the positioning through holes of the separator and the high-rigidity member can be arbitrary set, the separator and the high-rigidity member each preferably have two positioning through holes.

Then, one of the two positioning through holes can be used as a reference, and the other can be used as a through hole for absorbing the dimensional tolerances in positioning, for example.

The high-rigidity member is preferably made of an insulating material.

In addition to the configuration as a fuel cell described above, the present invention can be implemented as an invention of a fuel cell system including the fuel cell.

A second aspect of the present invention relates to a laminate having an electrolyte membrane, an anode provided on one surface of the electrolyte membrane, and a cathode provided on the other surface of the electrolyte membrane. The laminates has a seal member integrally formed on an outer periphery thereof for preventing leakage of reactant gases supplied onto a surface of the laminate, and a high-rigidity member surrounding at least a part of the seal member and having higher rigidity than the seal member.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein.

FIG. 1 is a perspective view illustrating the general configuration of a fuel cell stack 100 as a first embodiment of the present invention.

FIGS. 2A to 2D are plan views of components of a separator 41 and the separator 41 itself.

FIGS. 3A and 3B are explanatory views of a seal gasket-integrated MEA 45.

FIGS. 4A to 4C are explanatory views of a seal gasket-integrated MEA 45A of a second embodiment.

FIGS. 5A to 5C are explanatory views of a seat gasket-integrated MEA 45B of a third embodiment.

FIG. 6 is a perspective view illustrating the general configuration of a fuel cell stack 100C of a fourth embodiment.

FIGS. 7A to 7D are plan views of components of a separator 41C and the separator 41C itself.

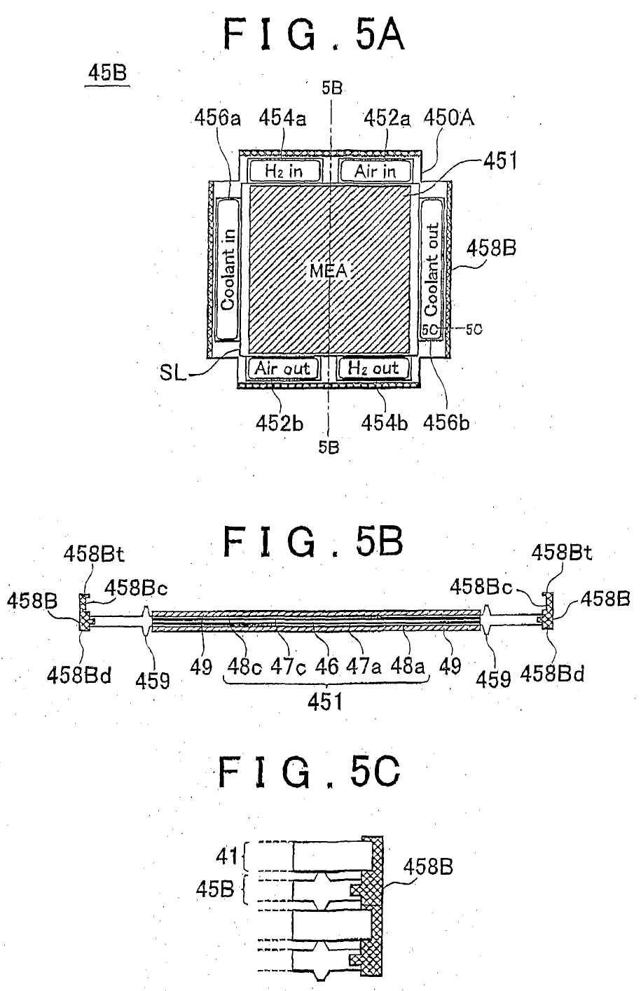

FIGS. 5A to 8C are explanatory views of a seal gasket-integrated MEA 45C of the fourth embodiment.

FIGS. 9A to 9C are explanatory views of a seal gasket-integrated MEA 45D of a fifth embodiment.

### DETAILED DESCRIPTION OF PREFERRED EMBODIMENTS

Description is hereinafter made of the present invention based on embodiments thereof in the following order.
A. First Embodiment:

A1. Configuration of fuel cell stack:

A2. Fuel cell module:
A2.1. Separator:
A2.2. Seal gasket-integrated MEA:

B. Second Embodiment:

C. Third Embodiment:

D. Fourth Embodiment:

E. Fifth Embodiment:

F. Modifications:

A. First Embodiment:

A1. Configuration of fuel cell stack:

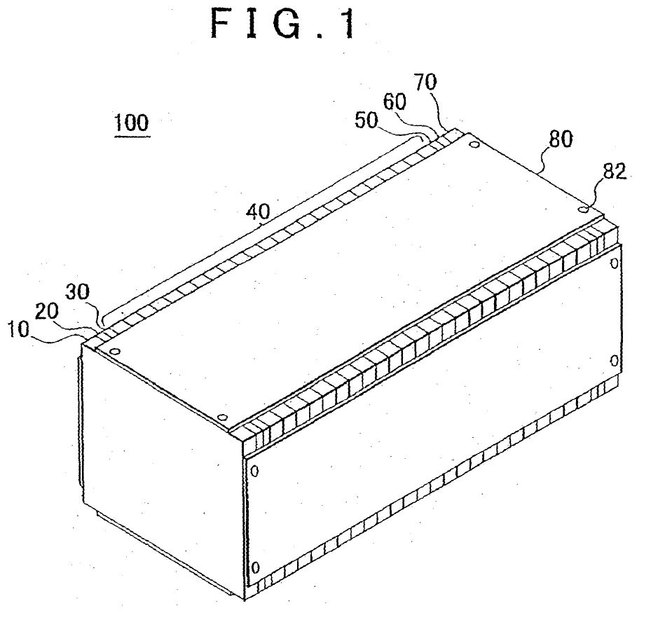

FIG. 1 is a perspective view illustrating the general configuration of a fuel cell stack 100 as a first embodiment of the present invention. The fuel cell stack 100 has a stack structure in which a plurality of cells for generating electricity through an electrochemical reaction between hydrogen and oxygen are stacked on top of each other with separators interposed therebetween. Each cell has an anode, a cathode, and an electrolyte membrane having proton conductivity interposed therebetween as described later. In this embodiment, polymer membranes are used as the electrolyte membranes. ks the electrolyte other electrolytes such as a solid oxide may be used. The number of the cells can be arbitrary set based on the output power demanded to the fuel cell stack 100.

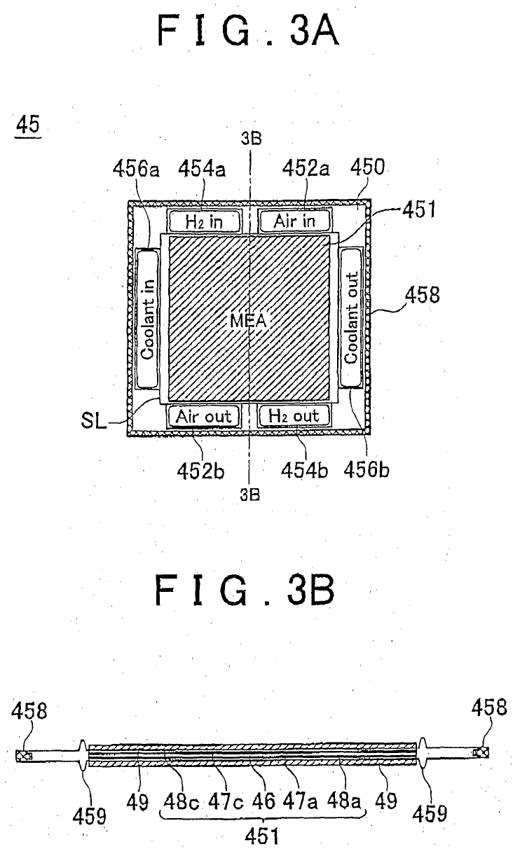

In the fuel cell stack 100, an end plate 10, an insulating plate 20, a current collecting plate 30, a plurality of fuel cell modules 40, a current collecting plate 50, an insulating plate 60, and an end plate 70 are stacked in this order from one end to the other. They have supply ports, discharge ports and passages (all not shown) to allow hydrogen as fuel gas, air as oxidant gas, and coolant to flow through the fuel cell stack 100. The hydrogen is supplied from a hydrogen tank (not shown). The air and the coolant are pressurized and supplied bad pumps (not shown). Each fuel cell module 40 is constituted of a separator 41 and a seal gasket-integrated MEA 45 in which a membrane-electrode assembly and a gasket are integrated, which are described later. The fuel cell module 40 and the seal gasket-integrated MEA 45 (see FIG. 3A) will be described later.

The fuel cell stack 100 also has tension plates 80 as shown in the drawing. In the fuel cell stack 100, a pressure is applied in the stacking direction of the stack structure in order to prevent deterioration of the cell performance caused by an increase in contact resistance in any part of the stack structure and so on and to ensure the sealability of the seal gasket-integrated MEA 45, and the tension plates 80 are fixed to the end plates 10 and 70 at opposite ends of the fuel cell stack 100 by bolts 82 to fasten the fuel cell modules 40 by a prescribed fastening force in the direction in which they are stacked.

The end plates 10 and 70, and the tension plates 80 are made of a metal such as steel to ensure rigidity. The insulating plates 20 and 60 are made of an insulating material such as rubber or resin. The current collecting plates 30 and 50 are a gas-impermeable conductive plate such as densified carbon or copper plate. Each of the current collecting plates 30 and 50 has an output terminal (not shown) so that the electric power generated in the fuel cell stack 100 can be outputted.

A2. Fuel cell module:

As described before, each fuel cell module 40 has a separator 41 and a seal gasket-integrated MEA 45. The separator 41 and the seal gasket-integrated MEA 45 are described below.
A2.1. Separator:

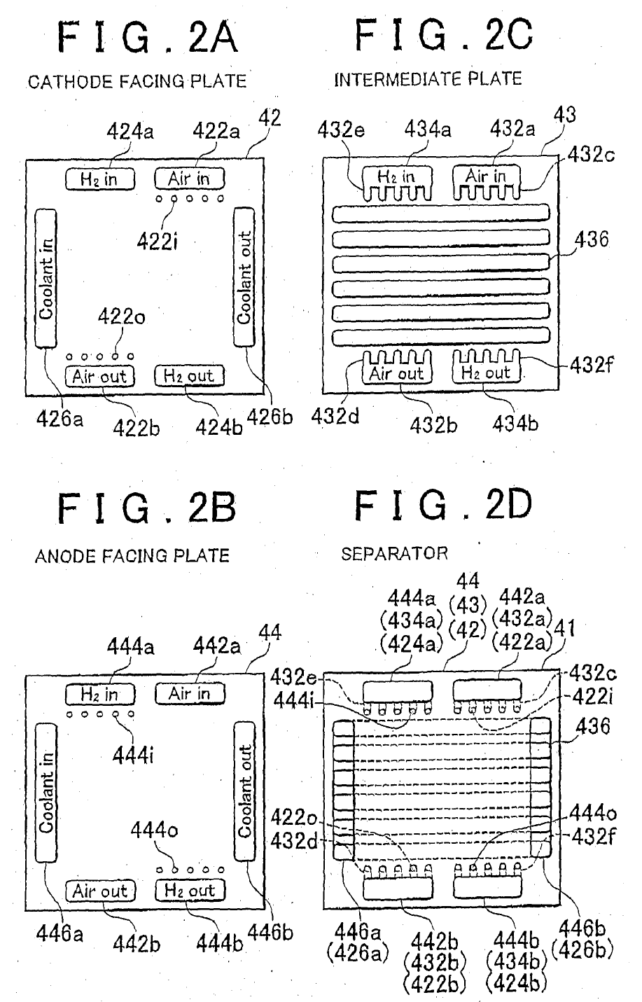

FIGS. 2A to 2D are plan views of components of a separator 41 and the separator 41 itself. The separator 41 in this embodiment is constituted of three metal flat plates each having a plurality of through holes, that is, a cathode facing plate 42, an intermediate plate 43, and an anode facing plate 44. The separator 41 is produced by stacking the cathode facing plate 42, the intermediate plate 43 and the anode facing plate 44 in this order and joining the plates by hot-pressing. In this embodiment, the cathode facing plate 42, the intermediate plate 43 and the anode facing plate 44 are stainless steel flat plates having the same square shape. As the cathode facing plate 42, the intermediate plate 43 and the anode facing plate 44, flat plates of other metal such as titanium or aluminum instead of stainless steel may be used. As the intermediate plate 43, a resin plate may be used.

FIG. 2A is a plan view of the cathode facing plate 42, which is in contact with the cathode side surface of the seal gasket-integrated MEA 45. As shown in the drawing, the cathode facing plate 42 has an air supplying through hole 422a, a plurality of air supply ports 422i, a plurality of air discharge ports 422o, an air discharging through hole 422b, a hydrogen supplying through hole 424a, a hydrogen discharging through hole 424b, a coolant supplying through hole 426a, and a coolant discharging through hole 426b. In this embodiment, the air supplying through hole 422a, the air discharging through hole 422b, the hydrogen supplying through hole 424a, the hydrogen discharging through hole 424b, the coolant supplying through hole 426a, the coolant discharging through hole 426b have generally rectangular shapes, and the air supply ports 422i and the air discharge ports 422o are of a circular shape and have the same diameter.

FIG. 2B is a plan view of the anode facing plate 44, which is in contact with the anode side surface of the seal gasket-integrated MEA 45. As shown in the drawing, the anode facing plate 44 has an air supplying through hole 442a, an air discharging through hole 442b, a hydrogen supplying through hole 444a, a plurality of hydrogen supply ports 444i, a plurality of hydrogen discharge ports 444o, a hydrogen discharging through hole 444b, a coolant supplying through hole 446a, and a coolant discharging through hole 446b, In this embodiment, the air supplying through hole 442a, the air discharging through hole 442b, the hydrogen supplying through hole 444a, the hydrogen discharging through hole 444b, the coolant supplying through hole 446a, and the coolant discharging through hole 446b have generally rectangular shapes, and the hydrogen supply ports 444i and the hydrogen discharge ports 444o are of a circular shape and have the same diameter.

FIG. 2C is a plan view of the intermediate plate 43. As shown in the drawing, the intermediate plate 43 has an air supplying through hole 432a, an air discharging through hole 432b, a hydrogen supplying through hole 434a, a hydrogen discharging through hole 434b, a plurality of coolant passage-forming through holes 436. The air supplying through hole 432a has a plurality of air supplying passage-forming portions 432c for allowing air to flow from the air supplying through hole 432a to the air supply ports 422i of the cathode facing plate 42. The air discharging through hole 432b has a plurality of air discharging passage-forming portions 432d for allowing air to flow from the air discharge ports 4220 of the cathode facing plate 42 to the air discharging through hole 432b. The hydrogen supplying through hole 434a has a plurality of hydrogen supplying passage-forming portions 432e for allowing hydrogen to flow from the hydrogen supplying through hole 434a to the hydrogen supply ports 444i of the anode facing plate 44. The hydrogen discharging through hole 434b has a plurality of hydrogen discharging passage-forming portion 432f for allowing hydrogen to flow from the hydrogen discharge ports 444o of the anode facing plate 44 to the hydrogen discharging through hole 434b.

FIG. 2D is a plan view of the separator 41. Here, a plan view is shown in view from the anode facing plate 44 side.

As can be understood from FIG. 2D, the air supplying through holes 442a, 432a, and 422a are formed in the same position through the anode facing plate 44, the intermediate plate 43 and the cathode facing plate 42. The air discharging through holes 442b, 432b, and 422b are formed in the same position. The hydrogen supplying through holes 444a, 434a, and 424a are formed in the same position. The hydrogen discharging through holes 444b, 434b, and 424b are formed in the same position.

The coolant supplying through holes 446a and 426a are formed in the same position through the anode facing plate 44 and the cathode facing plate 42. The coolant discharging through holes 446b and 426b are formed in the same position.

Each of the coolant passage-forming through holes 436 of the intermediate plate 43 is formed to have a first end overlapping with the coolant supplying through hole 446a of the anode facing plate 44 and the coolant supplying through hole 426a of the cathode facing plate 42, and a second end overlapping with the coolant discharging through hole 446b of the anode facing plate 44 and the coolant discharging through hole 426b of the cathode facing plate 42.

In the intermediate plate 43, the widths of the air supplying passage-forming portions 432c, the air discharging passage-forming portions 432d, the hydrogen supplying passage-forming portions 432e, and the hydrogen discharging passage-forming portions 432f are respectively greater than the diameter of the air supply ports 422i and the air discharge ports 422o of the cathode facing plate 42 and the hydrogen supply ports 444i and the hydrogen discharge ports 444o of the anode facing plate 44. Therefore, even if these portions are slightly offset from the ports when the cathode facing plate 42, the intermediate plate 43 and the anode facing plate 44 are stacked and joined together, air and hydrogen can be allowed to flow through desired routes.

In this separator 41, hydrogen, air and coolant flow as described below. Some of hydrogen flowing through the hydrogen supplying through hole 424a of the cathode facing plate 42, the hydrogen supplying through hole 434a of the intermediate plate 43, and the hydrogen supplying through hole 444a of the anode facing plate 44 is separated at the hydrogen supplying through hole 434a of the intermediate plate 43, flows through the hydrogen supplying passage-forming portions 432e, and is supplied from the hydrogen supply ports 444i of the anode facing plate 44 in a direction perpendicular to an anode of an MEA section 451 of the seal gasket-integrated MEA 45, which is described later. Anode off gas discharged from the anode is discharged through the hydrogen discharge ports 444o of the anode facing plate 44 and the hydrogen discharging passage-forming portions 432f of the intermediate plate 43.

Some of air flowing through the air supplying through hole 442a of the anode facing plate 44, the air supplying through hole 432a of the intermediate plate 43 and the air supplying through hole 422a of the cathode facing plate 42 is separated at the air supplying through hole 432a of the intermediate plate 43, flows through the air supplying passage-forming portions 432c, and is supplied from the air supply ports 422,i of the cathode facing plate 42 in a direction perpendicular to a cathode of the MEA section 451 of the seal gasket-integrated MEA 45, which is described later. Cathode off gas discharged from the cathode is discharged through the air discharge ports 422o of the cathode facing plate 42 and the air discharging passage-forming portions 432d of the intermediate plate 43.

Some of coolant flowing through the coolant supplying through hole 446a of the anode facing plate 44, the first ends of the coolant passage-forming through holes 436 of the intermediate plate 43, and the coolant supplying through hole 426a of the cathode facing plate 42 is separated at the coolant passage-forming through holes 436 of the intermediate plate 43, flows through the intermediate plate 43, and is discharged from the second ends of the coolant passage-forming through holes 436.

A2.2. Seal gasket-integrated MEA:

FIGS. 3A and 3B are explanatory views of a seal gasket-integrated MEA 45. FIG. 3A is a plan view from the cathode side of the seal gasket-integrated MEA. FIG. 3B is a cross-sectional view taken along the line 3B-3B of FIG. 3A. The seal gasket-integrated MEA 45 has the same external shape as the separator 41.

As shown in the drawing, the seal gasket-integrated MEA 45 has an MEA section 451 and a frame 450 surrounding and supporting the MEA section 451. A high-rigidity member 458 having higher rigidity than the frame 450 surrounds the frame 450. The high-rigidity member 458 is a member for preventing deformation of the frame 450. As can be known from FIG. 3B, the surface levels of the frame 450 and the high-rigidity member 458 are generally the same.

Although silicone rubber is used for the frame 450 in this embodiment, the present invention is not limited thereto. Other material having gas impermeability, elasticity, and heat resistance may be used. In this embodiment, an insulating hard resin is used for the high-rigidity member 458.

The MEA section 451 is a membrane-electrode assembly in which a cathode catalyst layer 47c and a cathode diffusion layer 48c are laminated in this order on one surface (cathode side surface) of an electrolyte membrane 46 and an anode catalyst layer 47a and an anode diffusion layer 48a are laminated in this order on the other surface (anode side surface) of the electrolyte membrane 46 as shown in FIG. 3B. In this embodiment, carbon porous bodies are used as the anode diffusion layer 48a and the cathode diffusion layer 48c. Also in this embodiment, metal porous layers 49 are stacked on both sides of the MEA section 451, which function as gas passage layers capable of allowing air, hydrogen and air to flow through it when the seal gasket-integrated MEA 45 is stacked on the separator 41. Since the cathode diffusion layer 48c, the anode diffusion layer 48a and the metal porous layer 49 are used, gas can be dispersed and supplied onto the entire surfaces of the anode and the cathode efficiently. For the gas passage layers, other materials having electrical conductivity and gas diffusibility such as carbon may be used in place of the metal porous body.

The frame 450 has an air supplying through hole 452a, a hydrogen supplying through hole 454a, an air discharging through hole 452b, a hydrogen discharging through hole 454b, a coolant supplying through hole 456a, and a coolant discharging through hole 456b as in the case with the separator 41 as shown in FIG. 3A. Sealing parts 459 are integrally provided around the through holes and the MEA section 451 to form a seal line SL shown by thin lines in FIG. 3A. That is, the frame 450 functions as a gasket which prevents leakage of hydrogen, oxygen and coolant.

According to the fuel cell stack 100 of the first embodiment described above, the seal gasket-integrated MEA 45 has a high-rigidity member 458 around the frame 450, deformation of the frame 450 at supplying of reactant gases can be prevented, and deterioration of sealability can be prevented.

The seal gasket-integrated MEA 45 is integrally formed by, for example, injection molding. If the high-rigidity member 458 is not provided around the frame 450, the frame 450 is largely deformed at the time of production since the linear expansion coefficient of the frame 450 made of silicone rubber is greater than that of the MEA section 451. In the seal gasket-integrated MEA 45 of this embodiment, since the high-rigidity member 458 is integrally formed around the frame 450, the deformation of the frame 450 at the time of production can be prevented. This can also be applicable to the other embodiments described below.

B. Second Embodiment:

The configuration of a fuel cell stack of the second embodiment is the same as that of the fuel cell stack 100 of the first embodiment except for the seal gasket-integrated MEA. The seal gasket-integrated MEA in the second embodiment is described below.

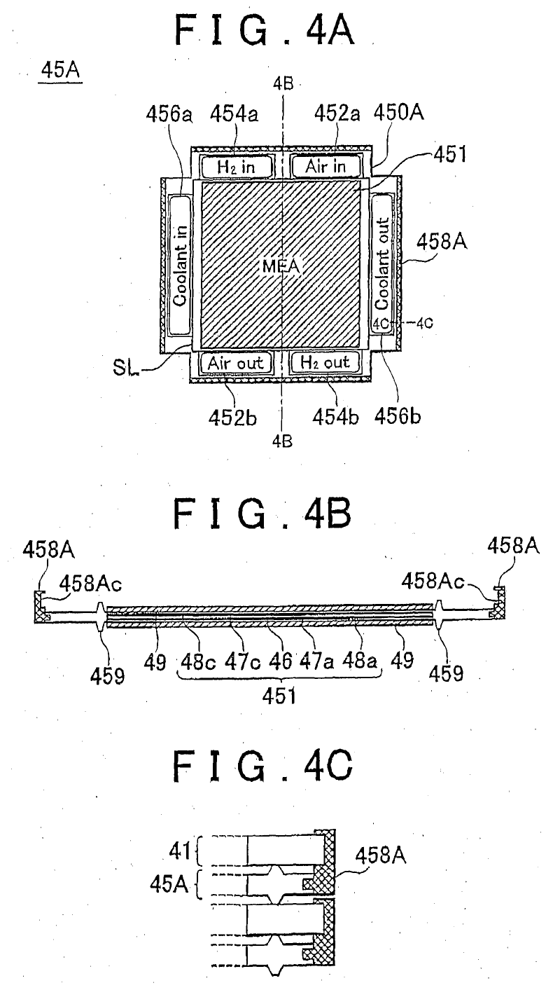

FIGS. 4A to 4C are explanatory views of a seal gasket-integrated MEA 45A of a second embodiment. FIG. 4A is a plan view of a seal gasket-integrated MEA 45A. FIG. 4B is a cross-sectional view taken along the line 4B-4B of FIG. 4A. FIG. 4C is a cross-sectional view taken along the 4C-4C of FIG. 4A when the separators 41 and the seal gasket-integrated MEAs 45A are stacked alternately.

The seal gasket-integrated MEA 45A of this embodiment has a frame 450A, as shown in FIG. 4A, having a shape which can be obtained by cutting off the four corners of the frame 450 of the seal gasket-integrated MEA 45 of the first embodiment. The seal gasket-integrated MEA 45A has an MEA section 451, an air supplying through hole 452a, an air discharging through hole 452b, a hydrogen supplying through hole 454a, a hydrogen discharging through hole 454b, a coolant supplying through hole 456a, and a coolant discharging through hole 456b, which are the same as those of the seal gasket-integrated MEA 45 of the first embodiment.

In the seal gasket-integrated MEA 45A, high-rigidity members 458A are disposed on the four peripheral edges of the frame 450A. Each of the high-rigidity members 458A has a recess 458Ac shown in FIG. 4B in its inner edge which can receive a peripheral edge of a separator 41 when the seal gasket-integrated MEA 45A and the separator 41 are stacked on top of each other as shown in FIG. 4C. Therefore, when the separator 41 and the seal gasket-integrated MEA 45A are stacked on top of each other, the positioning of the separator 41 in a surface direction can be made with ease and high accuracy. Also, lateral displacement of the separator 41 and the seal gasket-integrated MEA 45A from each other can be prevented.

According to the fuel cell stack of the second embodiment described above, since the seal gasket-integrated MEA 45A has high-rigidity members 458A around the frame 450A, deformation of the frame 450A at supplying of reactant gases can be prevented, and deterioration of sealability can be prevented as in the case with the fuel cell stack 100 of the first embodiment.

C. Third Embodiment:

The configuration of a fuel cell stack of the third embodiment is the same as that of the fuel cell stack 100 of the first embodiment and the second embodiment except for the seal gasket-integrated MEA. Also, as described later, the seal gasket-integrated MEA is the same as the seal gasket-integrated MEA 45A of the second embodiment except for the high-rigidity members. The seal gasket-integrated MEA in the third embodiment is described below.

FIGS. 5A to 5C are explanatory views of a seal gasket-integrated MEA 45B of a third embodiment. FIG. 5A is a plan view of the seal gasket-integrated MEA 45B. FIG. 5B is a cross-sectional view taken along the line 5B-5B of FIG. 5A. FIG. 5C is a cross-sectional view taken along the 5C-5C of FIG. 5A when the separators 41 and the seal gasket-integrated MEAs 45B are stacked alternately.

As shown in FIG. 5A, the seal gasket-integrated MEA 45B of this embodiment has a frame 450A having a shape which can be obtained by cutting off the four corners of the frame 450 of the seal gasket-integrated MEA 45 of the first embodiment as in the case with the seal gasket-integrated MEA 45A of the second embodiment. The seal gasket-integrated MEA 45B has an MEA section 451, an air supplying through hole 452a, an air discharging through hole 452b, a hydrogen supplying through hole 454a, a hydrogen discharging through hole 454b, a coolant supplying through hole 456a, and a coolant discharging through hole 456b, which are the same as those of the seal gasket-integrated MEAs 45 and 45A of the first and second embodiments.

In the seal gasket-integrated MEA 45B, high-rigidity members 458B are disposed on the four peripheral edges of the frame 450A. Each of the high-rigidity members 458B has a recess 458Bc in its inner edge which can receive a peripheral edge of a separator 41 when the seal gasket-integrated MEA 45B and the separator 41 are stacked on top of each other as shown in FIGS. 5B and 5C. Therefore, when the separator 41 and the seal gasket-integrated MEA 45B are stacked on top of each other, the positioning of the separator 41 in a surface direction can be made with ease and high accuracy. Also, lateral displacement of the separator 41 and the seal gasket-integrated MEA 45B from each other can be prevented.

Each of the high-rigidity members 458B has an extending portion which, when a plurality of seal gasket-integrated MEAs 45B and a plurality of separators 41 are stacked alternately and a fastening load is applied in the stacking direction, prevents the sealing parts 459 from being deformed excessively in the stacking direction in the following way: an upper surface 458Bt and a lower surface 458Bd of the high-rgidity members 458B of the seal gasket-integrated MEAs 45B adjacent to each other with a separator 41 interposed therebetween abut against each other. The extending portions can prevent deterioration of sealability caused by excessive deformation of the sealing parts 459 in the stacking direction. The extending portions can be regarded as restraining portions in the present invention.

According to the fuel cell stack of the third embodiment described above, since the seal gasket-integrated MEA 45B has the high-rigidity members 458B around the frame 450A, deformation of the frame 450A at supplying of reactant gases can be prevented, and deterioration of sealability can be prevented as in the fuel cell stacks of the first and second embodiments described before.

D. Fourth Embodiment:

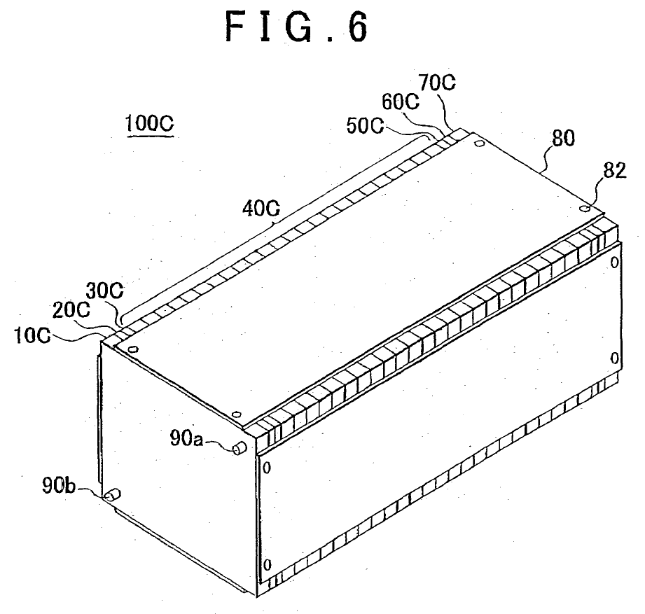

FIG. 6 is a perspective view illustrating the general configuration of a fuel cell stack 100C of a fourth embodiment. The fuel cell stack 100C has an end plate 10C, an insulating plate 20C, a current collecting plate 30C, a plurality of fuel cell modules 40C, a current collecting plate 50C, an insulating plate 60C, and an end plate 70C stacked in this order from one end to the other as in the case with the fuel cell stack 100 shown in FIG. 1. Each of the members has two through holes, and two positioning shafts 90a and 90b are inserted into the through holes for positioning in a surface direction at the time of stacking. Also, as in the case with the fuel cell stack 100 shown in FIG. 1, tension plates 80 are fixed to the end plate 10C and the end plate 70C by bolts 82. Each of the fuel cell modules 40C is constituted of a separator 41C and a seal gasket-integrated MEA 45C, which are described later.

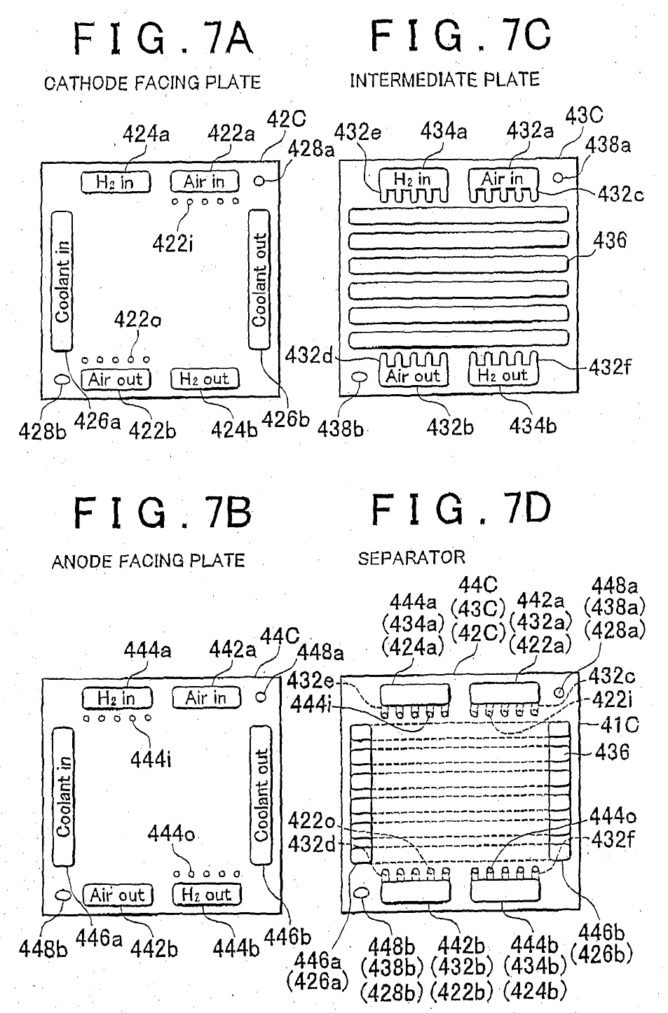

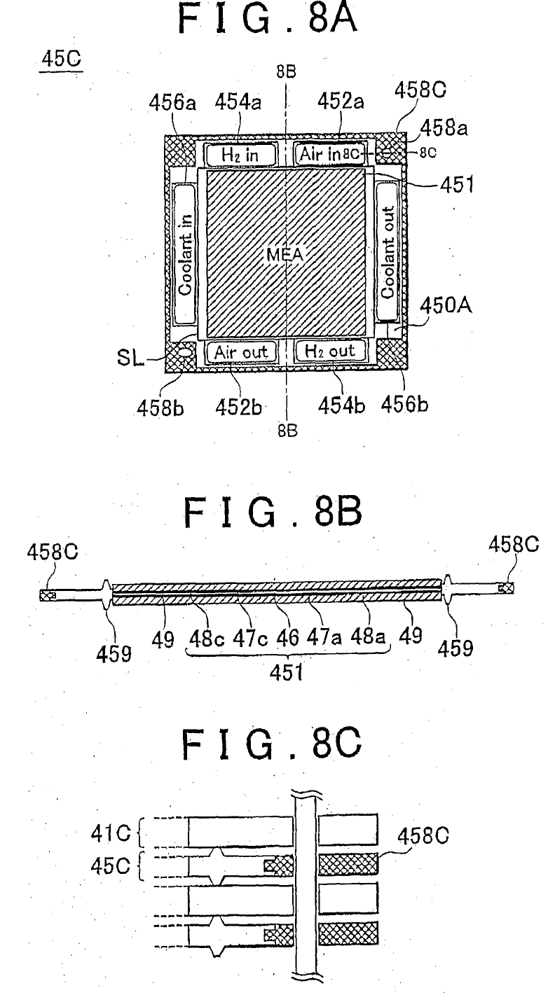

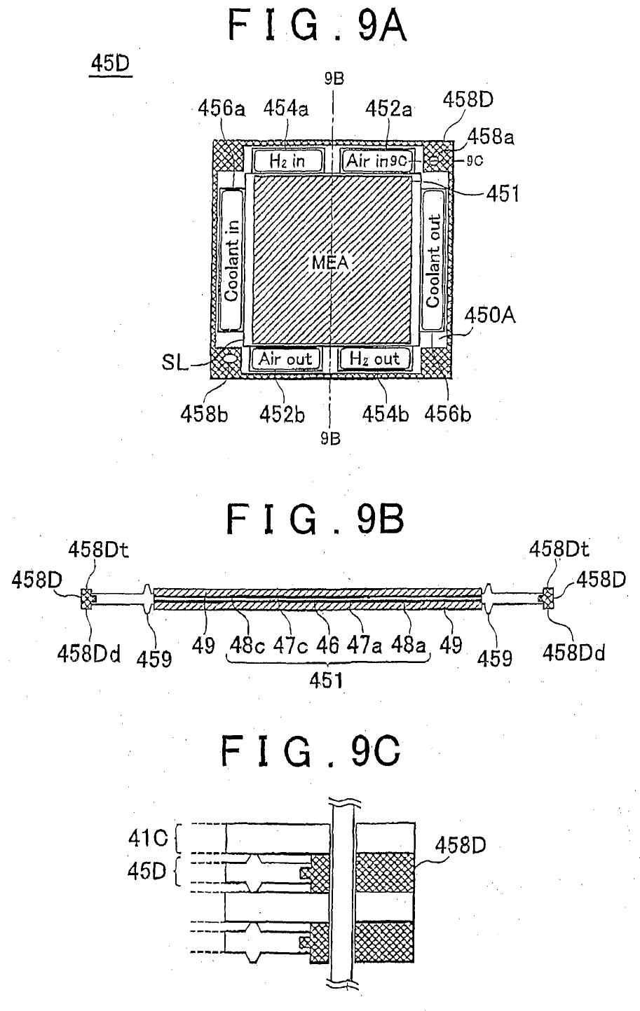

FIGS. 7A to 7D are plan views of components of a separator 41C and the separator 41C itself. The separator 41C of this embodiment is constituted of three metal flat plates each having a plurality of through holes, that is, a cathode facing plate 42C, an intermediate plate 43C, and an anode facing plate 44C, as in the case with the separator 41 shown in FIGS. 2A to 2D.

As shown in FIG. 7A, the cathode facing plate 42C has a positioning through hole 428a for receiving a positioning shaft 90a and a positioning through hole 428b for receiving a positioning shaft 90b. The positioning through hole 428a has a circular shape, and the positioning through hole 428b has an ellipsoidal shape. The cathode facing plate 42C is the same as the cathode facing plate 42 shown in FIG. 2A except for the positioning through holes 428a and 428b.

As shown in FIG. 7B, the anode facing plate 44C has a positioning through hole 448a for receiving the positioning shaft 90a, and a positioning through hole 448b for receiving the positioning shaft 90b. The positioning through hole 448a has a circular shape, and the positioning through hole, 448b has an ellipsoidal shape. The anode facing plate 44C are the same as the anode facing plate 44 shown in FIG. 2B except for the positioning through holes 448a and 448b.

As shown in FIG. 7C, the intermediate plate 43C has a positioning through hole 438a for receiving the positioning shaft 90a, and a positioning through hole 438b for receiving the positioning shaft 90b. The positioning through hole 438a has a circular shape, and the positioning through hole 438b has an ellipsoidal shape. The intermediate plate 43C is the same as the intermediate plate 43 shown in FIG. 2C except for the positioning through holes 438a and 438b.

FIGS. 5A to 8C are explanatory views of a seal gasket-integrated MEA 45C of the fourth embodiment. FIG. 8A is a plan view of the seal gasket-integrated MEA 45C. FIG. 5B is a cross-sectional view taken along the line 8B-8B of FIG. 8A. FIG. 8C is a cross-sectional view taken along the line 8C-8C of FIG. 8A when the separators 41C and the seal gasket-integrated MEAs 45C are stacked alternately.

As shown in FIG. 8A, the seal gasket-integrated MEA 45C of this embodiment has a frame 450A having a shape which can be obtained by cutting off the four corners of the frame 450 of the seal gasket-integrated MEA 45 of the first embodiment as in the case with the seal gasket-integrated MEA 45A of the second embodiment. The seal gasket-integrated MEA 45C has an MEA section 451, an air supplying through hole 452a, an air discharging through hole 452b, a hydrogen supplying through hole 454a, a hydrogen discharging through hole 454b, a coolant supplying through hole 456a, and a coolant discharging through hole 456b, which are the same as those of the seal gasket-integrated MEAs 45, 45A and 45B of the first to third embodiments.

In the seal gasket-integrated MEA 45C, a high-rigidity member 458C having higher rigidity than the frame 450A surrounds the frame 450A. The high-rigidity member 458C has a positioning through hole 458a for receiving the positioning shaft 90a, and a positioning through hole 458b for receiving the positioning shaft 90b. The positioning through hole 458a has a circular shape, and the positioning through hole 458b has an ellipsoidal shape. As shown in FIG. 8B, the surface levels of the frame 450A and the high-rigidity member 458C are generally the same.

According to the fuel cell stack 100C of the fourth embodiment described above, since the seal gasket-integrated MEA 45C has a high-rigidity member 458C around the frame 450A, deformation of the frame 450A at supplying of reactant gases can be prevented, and deterioration of sealability can be prevented as in the fuel cell stacks of the first to third embodiments described before.

Also, in this embodiment, the cathode facing plate 42C has the positioning through holes 428a and 428b, the intermediate plate 43C has the positioning through holes 438a and 438b, the anode facing plate 44C has the positioning through holes 448a and 448b, and the seal gasket-integrated MEA 45C has the positioning through holes 458a and 458b. Therefore, when the separator 41C and the seal gasket-integrated MEA 45C are stacked on top of each other, the positioning in a surface direction can be made With ease and high accuracy.

In addition, in this embodiment, the positioning through hole 428a of the cathode facing plate 42C, the positioning through hole 438a of the intermediate plate 43C, the positioning through hole 448a of the anode facing plate 44C, and the positioning through hole 458a of the seal gasket-integrated MEA 45C have a circular shape, The positioning through hole 428b of the cathode facing plate 42C, the positioning through hole 438b of the intermediate plate 43C, the positioning through hole 448b of the anode facing plate 44C, and the positioning through hole 458b of the seal gasket-integrated MEA 45C have an ellipsoidal shape. Therefore, the dimensional tolerances in positioning in a surface direction can be absorbed in stacking. This can also be applicable to the fifth embodiment described below.

E. Fifth Embodiment:

The configuration of a fuel cell stack according to a fifth embodiment is the same as that of the fuel cell stack 100C of the fourth embodiment except for the seal gasket-integrated MEA. Also, as described later, the seal gasket-integrated MEA is the same as the seal gasket-integrated MEA 45C of the fourth embodiment except for the high-rigidity member. The seal gasket-integrated MEA in the fifth embodiment is described below.

FIGS. 9A to 9C are explanatory views of a seal gasket-integrated MEA 45D of a fifth embodiment. FIG. 9A is a plan view of the seal gasket-integrated MEA 45D. FIG. 9B is a cross-sectional view taken along the line 9B-9B of FIG. 9A. FIG. 9C is a cross-sectional view taken along the line 9C-9C of FIG. 9A when the separators 41C and the seal gasket-integrated MEAs 45D are stacked alternately.

As shown in FIG. 9A, seal gasket-integrated MEA 45D of this embodiment has a frame 450A having a shape which can be obtained by cutting off the four corners of the frame 450 of the seal gasket-integrated MEA 45 of the first embodiment as in the case with the seal gasket-integrated MEA 45A of the second embodiment. The seal gasket-integrated MEA 45D has an MEA section 451, an air supplying through hole 452a, an air discharging through hole 452b, a hydrogen supplying through hole 454a, a hydrogen discharging through hole 454b, a coolant supplying through hole 456a, and a coolant discharging through hole 456b, which are the same as those of the seal gasket-integrated MEAs 45, 45A, 45B and 45C of the first to fourth embodiments.

In the seal gasket-integrated MEA 45D, a high-rigidity member 458D surrounds the frame 450A. Each of the high-rigidity members 458B has an extending portion shown in FIGS. 9B and 9C which, when a plurality of seal gasket-integrated MEAs 458B and a plurality of separators 41C are stacked alternately and a fastening load is applied in the stacking direction, prevents the sealing parts 459 from being deformed excessively in the stacking direction in the following way: an upper surface 458Dt and a lower surface 458Dd of the high-rigidity members 458B of the seal gasket-integrated MEAs 458B adjacent to each other with a separator 41C interposed therebetween abut against each other. The extending portions can prevent deterioration of sealability caused by excessive deformation of the sealing parts 459 in the stacking direction.

According to the fuel cell stack of the fifth embodiment described above, since the seal gasket-integrated MEA 45D has the high-rigidity member 458D around the frame 450A, deformation of the frame 450A at supplying of reactant gases can be prevented, and deterioration of sealability can be prevented as in the fuel cell stacks of the first to fourth embodiments described before.

F. Modifications:

Although some embodiments of the present invention have been described above, the present invention is not limited to the embodiments, and various modifications may be made thereto without departing from the object thereof. For example, the following modifications can be made.

F1. Modification 1:

The frame and the high-rigidity member or members are integrally formed when the seal gasket-integrated MEA is produced in the above embodiments, the present invention is not limited thereto. The frame and the high-rigidity member or members may be formed separately and joined together.

F2. Modification 2:

Although there are two positioning shafts, and the separator and the seal gasket-integrated MEA have two positioning through holes in the fourth embodiment and the fifth embodiment, the present invention is not limited thereto. The numbers of the positioning shafts and the positioning through holes can be set arbitrarily.

F3. Modification 3:

Although an insulating material is used for the high-rigidity member or members provided around the seal gasket-integrated MEA in the above embodiments, the present invention is not limited thereto. When the high-rigidity member or members and the separator do not contact each other in a fuel cell stack as in the fuel cell stack 100 of the first embodiment, for example, the high-rigidity member or members can be made of a conductive material.

F4. Modification 4:

Although the separator is constituted of three plates: a cathode facing plate; an intermediate plate; and an anode facing plate, in the above embodiments, the present invention is not limited thereto. For example, a separator formed by shaping one block-shaped member of carbon or the like may be used.

F5. Modification 5:

Although the fuel cell stack 100 has tension plates 80 in the above embodiments, the fuel cell stack 100 does not have the tension plates 80. In this case, a mechanism for applying a pressure in the stacking direction of the fuel cell stack 100 may be provided. However, when the fuel cell stack 100 has tension plates 80 as in the above embodiments, since the tension plates 80 can constrain the fuel cell modules 40 from outside, an advantage can be obtained that lateral displacement (displacement in a surface direction) of the separators 41 and the seal gasket-integrated MEAs 45 can be prevented even when the pressure applied in the stacking direction of the fuel cell stack is relatively low.

1. (canceled)

2. The fuel cell according to claim 15, wherein the seal member is made of an elastic material.

3. The fuel cell according to claim 15, wherein the high-rigidity member is formed integrally with the seal member.

4. The fuel cell according to claim 15, wherein the high-rigidity member and the seal member are formed separately.

5. The fuel cell according to claim 15, wherein the high-rigidity member has a restraining portion that prevents deformation of the seal member in the stacking direction of the stack structure.

6. The fuel cell according to claim 5, wherein the restraining portion is an extending portion in contact with the high-rigidity member of an adjacent laminate.

7. The fuel cell according to claim 15, wherein the high-rigidity member has a fitting portion fittable with at least a part of an outer periphery of the separator.

8. The fuel cell according to claim 15, wherein the separator and the high-rigidity member have a positioning through hole for use in positioning in a surface direction in stacking.

9. The fuel cell according to claim 8, wherein the separator and the high-rigidity member each have a plurality of positioning through holes.

10. The fuel cell according to claim 9, wherein the separator and the high-rigidity member each have two positioning through holes.

11. The fuel cell according to claim 8, wherein the positioning through holes of the separator and the high-rigidity member have different shapes.

12. The fuel cell according to claim 11, wherein one of the positioning through holes of the separator and the high-rigidity member has a circular shape and another has an ellipsoidal shape.

13. The fuel cell according to claim 15, wherein the high-rigidity member is made of an insulating material.

14. (canceled)

15. A fuel cell comprising:
a laminate including an electrolyte membrane; an anode provided on one surface of the electrolyte membrane; a cathode provided on the other surface of the electrolyte membrane; a seal member integrally formed on an outer periphery of the laminate that prevents leakage of reactant gases supplied onto a surface of the laminate; and a high-rigidity member surrounding at least a part of the seal member and having higher rigidity than the seal member, and
separators that sandwich the laminate.

16. A laminate comprising:
an electrolyte membrane;
an anode provided on one surface of the electrolyte membrane;
a cathode provided on the other surface of the electrolyte membrane;
a seal member integrally that is formed on an outer periphery of the laminate and prevents leakage of reactant gases supplied onto a surface of the laminate; and
a high-rigidity member surrounding at least a part of the seal member and having higher rigidity than the seal member.
